(19) United States
(12) Patent Application Publication
(10) Pub. No.: US 2013/0116884 A1
(43) Pub. Date: May 9, 2013

(54) APPARATUS AND METHOD FOR AGGREGATING HEALTH MANAGEMENT INFORMATION

(71) Applicants: Mark Howard Thomson, Kentwood, MI (US); Jonathan Mark Dunsdon, Glenville, NY (US)

(72) Inventors: Mark Howard Thomson, Kentwood, MI (US); Jonathan Mark Dunsdon, Glenville, NY (US)

(73) Assignee: GE AVIATION SYSTEMS LIMITED, Cheltenham (GB)

(21) Appl. No.: 13/402,499

(22) Filed: Feb. 22, 2012

(30) Foreign Application Priority Data
Nov. 9, 2011 (GB) 11193257

(51) Int. Cl. G01M 17/00

(52) U.S. Cl. 701/32.8; 701/33.4

(57) ABSTRACT

An apparatus and method for aggregating health management information includes an aircraft having a flight computer coupled to a plurality of aircraft systems. Each system has a built in test (BIT) protocol that self-diagnoses a health of the system and outputs corresponding BIT data to the flight computer for contemporaneous display on a flight display.

### CROSS-REFERENCE TO RELATED APPLICATIONS

This application claims priority under 35 U.S.C. §119 to British Patent Application No. 11193257, filed Nov. 9, 2011, the disclosure of which is incorporated herein by reference.

### BACKGROUND OF THE INVENTION

Contemporary aircraft may include an Onboard Maintenance System (OMS) or a health monitoring or Integrated Vehicle Health Management (IVHM) system to assist in diagnosing or predicting faults in the aircraft. Such systems may collect various aircraft data for any irregularities or other signs of a fault or problem with the aircraft. Legacy aircraft such as the Airbus A320, the Boeing 737, and legacy business jets, by way of non-limiting examples only, pre-date such modern onboard or integrated systems. Thus, the ability to diagnose or predict faults in such aircraft is limited.

### BRIEF DESCRIPTION OF THE INVENTION

In one embodiment, an aircraft includes a plurality of aircraft systems having a built in test (BIT) that outputs corresponding BIT data upon execution, a cockpit having a flight control computer in communication with the plurality of aircraft systems and executing a flight control program providing for manual interrogation of the BITs, a flight display in communication with the flight control computer via a display link over which at least some of the BIT data is displayed in response to the manual interrogation, and an avionics unit in communication with the display link and executing a data collection program to capture and store at least some of the BIT data communicated over the display link.

In another embodiment, a method of aggregating health management information from systems in an aircraft includes detecting in the flight control computer an execution of a BIT in at least one system in the aircraft in response to an interrogation, capturing corresponding BIT data outputted to the flight control computer in response to the execution of the BIT, and storing in a non-transitory medium on the aircraft, the captured corresponding BIT data for later retrieval and analysis.

### BRIEF DESCRIPTION OF THE DRAWINGS

In the drawings:

FIG. 1 is a schematic view of a portion of an aircraft according to an embodiment of the invention.

### DESCRIPTION OF EMBODIMENTS OF THE INVENTION

Legacy aircraft have a level of useful health management information resident within their avionic and electro-mechanical systems but this information is currently under-utilized for managing the health of aircraft and aircraft fleets because the information is only available by manual interrogation via aircraft displays, and the information is not stored centrally after it is displayed. The embodiments of the invention described herein enable the creation of an effective OMS and/or IVHM system for such legacy aircraft collecting and/or storing the information that is currently discarded after display.

For purposes of this description, an OMS may be defined according to the Aeronautical Radio, Incorporated (ARINC) report 624-1 in the DESIGN GUIDANCE FOR ONBOARD MAINTENANCE SYSTEM most recently published Aug. 30, 1993, and first adopted in July 1991, the purpose section of which states than an OMS, “incorporates the traditional areas of failure monitoring and fault detection, BITE, BITE access, and an airplane condition monitoring system (ACMS), formerly known as aircraft integrated data system (AIDS). It further describes the capability to provide onboard maintenance documentation (OMD) and the requirement for total integration of these functions. It describes the requirements for all the elements of the OMS, including a central maintenance computer (or CMC function) and all the member systems which interface with it.”

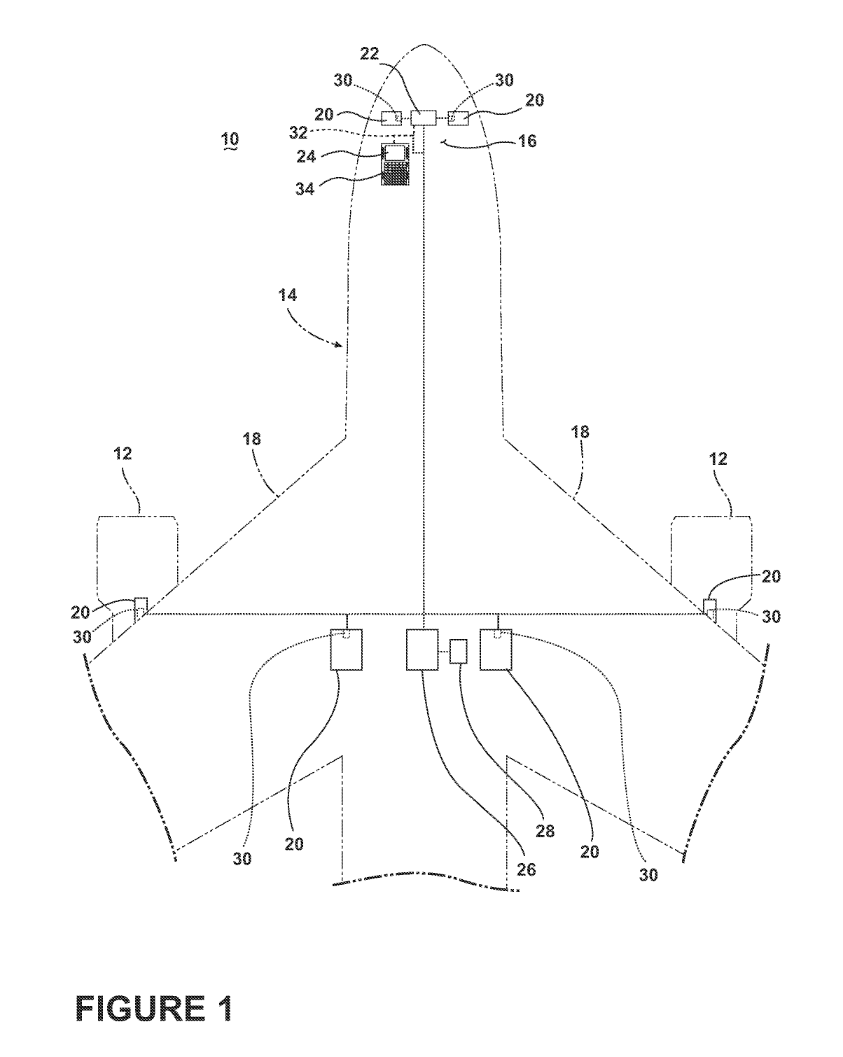

FIG. 1 schematically illustrates a portion of the aircraft 10 in accordance with an embodiment of the present disclosure. One or more propulsion engines 12 coupled to a fuselage 14, a cockpit 16 positioned in the fuselage 14, and wing assemblies 18 extending outward from the fuselage 14 may be included in the aircraft 10. Further, a plurality of aircraft systems 20 that enable proper operation of the aircraft 10 may be included as well as a flight control computer 22, a flight display 24, an avionics unit 26, and a wireless communication system 28. While a commercial aircraft has been illustrated, it is contemplated that the embodiments of the invention may be used in any type of legacy aircraft, for example, without limitation, fixed-wing, rotating-wing, rocket, personal aircraft, and military aircraft.

The plurality of aircraft systems 20 have been shown schematically and are illustrated as including a built in test (BIT) 30 that outputs corresponding BIT data upon execution. The plurality of aircraft systems 20 may include any suitable aircraft system having a BIT 30. The plurality of aircraft systems 20 may reside within the cockpit 16, within the electronics and equipment bay (not shown), or in other locations throughout the aircraft 10 including associated with the engines 12. Such aircraft systems 20 may include but are not limited to: a Digital Flight Control System, an Auto Throttle, an Inertial Reference System, an Electronic Flight Instrument System, a Common Display System, an Electronic Engine Control, an Auxiliary Power Unit, an Air Data Inertial Reference System, a Fuel Quantity Indication System, an Integrated Display Unit, a Digital Flight Data Acquisition Unit or parameter data aggregator, a Proximity Switch Electronic Unit, a Flap/Slat Electronic Unit, an Advanced Engine Vibration Monitor, and a Communication Management Unit. The BIT 30 may be any suitable mechanism that permits the corresponding aircraft system 20 in which it is included to test itself

The flight control computer 22, which may include a flight management computer, may among other things automate the tasks of piloting and tracking the flight plan of the aircraft 10. The flight control computer 22 may include or be associated with, any suitable number of individual microprocessors, power supplies, storage devices, interface cards, auto flight systems, flight management computers, and other standard components. The flight control computer 22 may include or cooperate with any number of software programs (e.g., flight management programs) or instructions designed to carry out the various methods, process tasks, calculations, and control/display functions necessary for operation of the aircraft 10. The flight control computer 22 is illustrated as being in communication with the plurality of aircraft systems 20 and it is contemplated that the flight control computer 22 may execute a flight control program providing for manual interrogation of the BITs 30.

The flight display 24 may communicate with the flight control computer 22 via a display link 32 and the flight control computer 22 may drive the flight display 24 to generate a display thereon. In this manner, the flight display 24 may visually expresses information pertaining to the aircraft 10. The flight display 24 may be a primary flight display, a multipurpose control display unit, or other suitable flight display commonly included within the cockpit 16. By way of non-limiting example, the flight display 24 may be used for displaying flight information such as airspeed, altitude, attitude, and bearing of the aircraft 10.

A user interface 34 may be included in the cockpit 16 and may assume any form suitable for receiving input data from the flight crew. For example, such a user interface 34 may include one or more cursor devices disposed on or adjacent the flight display 24 and enabling the pilot to interact with a graphical user interface produced on the flight display 24. As a further example, the user interface 34 may include a switch, button, dial, or basic user input device disposed at any suitable location within the aircraft cockpit 16.

The avionics unit 26 may be in communication with the display link 32 and may be capable of executing a data collection program to capture and store at least some of the BIT data communicated over the display link 32. The avionics unit 26 may be any suitable computer device on which a software program may be executed to monitor the display link 32 and capture at least some of the BIT data. It is contemplated that the avionics unit 26 may have memory (not shown) and may store at least some of the captured BIT data.

The wireless communication system 28 may be communicably coupled to the avionics unit 26 to transfer the stored BIT data off the aircraft 10. Such a wireless communication system 28 may be any variety of communication mechanism capable of wirelessly linking with other systems and devices and may include, but is not limited to, packet radio, satellite uplink, Wireless Fidelity (WiFi), WiMax, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof. It will also be understood that the particular type or mode of wireless communication is not critical to this invention, and later-developed wireless networks are certainly contemplated as within the scope of this invention. Further, the wireless communication system 28 may be communicably coupled with the avionics unit 26 through a wired link without changing the scope of this invention. Although only one wireless communication system 28 has been illustrated it is contemplated that the aircraft 10 may have multiple wireless communication systems communicably coupled with the avionics unit 26. Such multiple wireless communication systems may provide the aircraft 10 with the ability to transfer the BIT data off the aircraft 10 in a variety of ways such as by satellite, GSM, and WiFi.

During operation, the flight control computer 22 may be caused to initiate an interrogation of the at least one system in the aircraft. The flight control computer 22 may execute a flight control program providing for manual interrogation of the BITs 30. A user may cause the flight control computer 22 to cause the interrogation in the normal course of operation, in which case the BIT data may be captured and stored. More specifically, the flight crew may manually initiate a test of any of the plurality of aircraft systems 20 through the user interface 34, which may send a signal regarding same to the flight control computer 22. The corresponding aircraft systems 20 may respond to a corresponding interrogation command from the flight control computer 22. BIT data may be output to the flight control computer 22 in response to the execution of the BIT 30. The flight display 24 may communicate with the flight control computer 22 over the display link 32 and at least some of the corresponding BIT data may be displayed on the flight display 24 in response to the manual interrogation. The data collection program of the avionics unit 26 may capture and store at least some of the BIT data communicated over the display link 32.

In addition to such manual interrogation, the data collection program of the avionics unit 26 may generate interrogation commands for the BITs 30 during operation of the aircraft 10 and BIT data may be output to the flight control computer 22 in response to the execution of the BIT 30. Thus, the interrogation of the plurality of aircraft systems 20 by the flight control computer 22 may be caused by the aircraft itself. Such an interrogation may be automatic. It is contemplated that the interrogation of a system may be repeated and such a repeated interrogation may be part of a regular BIT data collection schedule. It is contemplated that the interrogation may be conducted at any time including when the aircraft 10 is or is not in flight. In this manner, the data collection program of the avionics unit 26 may poll the plurality of aircraft systems 20 without the need for manual interrogation. The data collection program of the avionics unit 26 may capture and store at least some of the BIT data from the polled plurality of aircraft systems 20.

Regardless of the manner in which the interrogation is initiated, at least some of the stored BIT data information may be transferred through the wireless communication system 28 off the aircraft 10 to another device such as a storage device. The BIT data may indicate any number of information regarding the aircraft system 20. By way of non-limiting examples, the BIT data may indicate detection of a fault, how the system actively responds to the fault or accommodates the fault, or annunciation or logging of the fault to warn of possible effects and/or aid in troubleshooting the faulty equipment. The BIT data may be analyzed for any irregularities or other signs of a fault or problem with the aircraft 10.

It is contemplated that a database of BIT data may be formed by transferring at least some of the stored BIT data from the memory of the avionics unit 26 onto a storage device housing the database. In this manner, a variety of aircraft data may be collected and analyzed for any irregularities or other signs of a fault or problem with the aircraft 10. The transferring of the BIT data onto the storage device may be done wirelessly as disclosed above. Alternatively, the BIT data may be retrieved from the avionics unit 26 and physically transferred onto the storage device housing the data base. Regardless of the method for transferring the stored BIT data, the database may then be queried for analysis.

Thus, the above described aircraft 10 may be capable of performing a method of aggregating health management information from the plurality of systems 20 in the aircraft 10. An embodiment of the method may include detecting in the flight control computer 22, an execution of a BIT 30 in at least one system 20 in the aircraft 10 in response to an interrogation regardless of how the interrogation is initiated. The method of aggregating the health management information may include capturing corresponding BIT data outputted to the flight control computer 22 in response to the execution of the BIT 30, and storing in a non-transitory medium on the aircraft 10, the captured corresponding BIT data for later retrieval and analysis. It is contemplated that detecting the execution of the BIT 30 may include monitoring the display link 32 between the at least one system 20 in the aircraft 10 and the flight display 24. In such case, capturing at least some of the BIT data may include capturing the at least some of the BIT data from the monitored display link 32.

It is also contemplated that during operation the avionics unit 26 may also collect other data from the plurality of aircraft systems 20 in addition to the BIT data. Such additional data may also be aggregating from the plurality of systems 20 in the aircraft 10. The additional data may also be transferred through the wireless communication system 28 off the aircraft 10 and may be analyzed to determine the health of the aircraft 10.

The above embodiments provide a variety of benefits including that BIT data may be collected and analyzed on legacy aircraft not equipped with contemporary OMS or IVHM. The technical effect being that the above described embodiments may utilize existing aircraft display interfaces and collect the BIT data on an onboard avionics unit for transmission off the aircraft. This may be done with minimal disturbance of wiring on the legacy aircraft and with minimal associated cost and minimal associated schedule impacts from taking the aircraft out of service to install the necessary components. Based on the collected, stored, and transmitted BIT data, more accurate predictions may be made for estimation of the life of aircraft components, and more cost effective condition-based maintenance may be recommended and employed with greater confidence. As the information may be transferred off the aircraft while it is in flight the above embodiments may also minimize the time on the ground needed for diagnosis and repair.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of aggregating health management information from systems in an aircraft having a flight control computer coupled to each system, wherein each system has a built in test (BIT) protocol that self-diagnoses a health of the system and outputs corresponding BIT data to the flight control computer for contemporaneous display on a cockpit display, the method comprising:
detecting in the flight control computer an execution of a BIT in at least one system in the aircraft in response to an interrogation;
capturing corresponding BIT data outputted to the flight control computer in response to the execution of the BIT; and
storing in a non-transitory medium on the aircraft, the captured corresponding BIT data for later retrieval and analysis.

2. The method of claim 1 wherein detecting the execution of the BIT comprises monitoring the display link between the at least one system in the aircraft and the cockpit display.

3. The method of claim 2 wherein capturing at least some of the BIT data comprises capturing the at least some of the BIT data from the monitored display link.

4. The method of claim 3 wherein the monitoring the display link and the capturing the at least some of the BIT data comprises providing a software program being executed on a computer device in communication with the display link, with the computer device having memory and storing at least some of the BIT data.

5. The method of claim 4, further comprising forming a database of BIT data that may be queried for analysis by transferring at least some of the stored BIT data from the memory onto a storage device.

6. The method of claim 5 wherein transferring at least some of the stored BIT data comprises wirelessly communicating the stored BIT data to the storage device housing the database.

7. The method of claim 6 wherein wirelessly communicating comprises at least one of a packet radio, satellite uplink, Wireless Fidelity, WiMax, Bluetooth, ZigBee, 3G wireless signal, code division multiple access wireless signal, global system for mobile communication, 4G wireless signal, long term evolution signal, and Ethernet.

8. The method of claim 1, further comprising causing the flight control computer to initiate an interrogation of the at least one system in the aircraft.

9. The method of claim 8 wherein the interrogation is repeated.

10. The method of claim 9 wherein the repeated interrogation is part of a regular BIT data collection schedule.

11. The method of claim 10 wherein the interrogation is conducted when the aircraft is not in flight.

12. The method of claim 11 wherein the interrogation is automatic.

13. An aircraft comprising:
a plurality of aircraft systems having a built in test (BIT) that outputs corresponding BIT data upon execution;
a cockpit having a flight control computer in communication with the plurality of aircraft systems and executing a flight control program providing for manual interrogation of the BITs;
a flight display in communication with the flight control computer via a display link over which at least some of the BIT data is displayed in response to the manual interrogation; and
an avionics unit in communication with the display link and executing a data collection program to capture and store at least some of the BIT data communicated over the display link.

14. The aircraft of claim 13 wherein the data collection program generates interrogation commands for the BITs to poll the plurality of aircraft systems, without a need for manual interrogation from the flight display.

15. The aircraft of claim 14 wherein the data collection program captures and stores at least some of the BIT data from the polled plurality of aircraft systems.

16. The aircraft of claim 15, further comprising a wireless communication system coupled to the avionics unit to transfer the stored BIT data off the aircraft.
